(19) United States
(12) Patent Application Publication
(10) Pub. No.: US 2004/0215999 A1
(43) Pub. Date: Oct. 28, 2004

(54) Non-volatile storage of operational conditions of integrated access device to facilitate post-mortem diagnostics

(75) Inventors: Christopher A. Otto, Madison, AL (US); Phillip Stone Herron, Huntsville, AL (US); Ian D. Locy, Madison, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., Huntsville, AL (US)

(21) Appl. No.: 10/412,864

(22) Filed: Apr. 14, 2003

(51) Int. Cl. H02H 3/05

(52) U.S. Cl. 714/4

(57) ABSTRACT

An operational condition capture mechanism within the communications control processor of an integrated access device stores in non-volatile (flash) memory prescribed state information associated with the operation of the communications control processor, in response to a catastrophic event that initiates a reboot of the device, and thereby interruption of the transmission of digital communication signals by the integrated access device, so as to facilitate subsequent off-line analysis (e.g., trouble-shooting) of the cause of the misoperation of the device, and interruption of digital communication service.

### FIELD OF THE INVENTION

The present invention relates in general to communication systems and subsystems therefor, and is particularly directed to an operational condition capture mechanism, which is operative to store, in non-volatile (flash) memory, state information associated with the operation of the communications control processor of an integrated access device, in response to the occurrence of a catastrophic event that initiates a reboot of the device (and consequential interruption of digital communication service), so as to facilitate subsequent off-line analysis (e.g., trouble-shooting) of the cause of the misoperation of the device.

### BACKGROUND OF THE INVENTION

The ability to conduct high-speed data communications between relatively remote data processing systems and associated subsystems is currently a principal requirement of a variety of industries and applications, such as business, educational, medical, financial and personal computer users. Moreover, it can be expected that present and future applications of such communications will continue to engender more such systems and services. One example of technology that has attracted particular interest in the telecommunication community is digital subscriber line (DSL) service. DSL technology enables a public service telephone network (PSTN) to use existing telephone copper wiring infrastructure to deliver a relatively high data bandwidth digital communication service, that is selected in accordance with expected data transmission rate, the type and length of data transport medium, and schemes for encoding and decoding data.

FIG. 1 is a reduced complexity diagram of the general architecture of a DSL system, having mutually compatible digital communication transceivers 1 and 3, respectively installed at relatively remotely separated ‘west’ and ‘east’ sites 2 and 4, and coupled to a communication link 10, such as a twisted pair of an existing copper plant. One of these transceivers, for example, the west site transceiver 1, may be installed in a digital subscriber line access multiplexer (DSLAM) 6 of a network controller site (such as a telephone company central office (CO)). The DSLAM is coupled with an associated network backbone 5 that provides access to a number of information sources 7 and the Internet 8. As such, the west site transceiver 1 is used for the transport of digital communication signals, such as asynchronous transfer mode (ATM)-based packetized voice and data, from the central office site 2 over the communication link 10, to an integrated access device (IAD) serving as the DSL transceiver 3 at the east end of the link, and may be coupled with a computer 9 at a customer premises, such as a home or office.

An integrated access device (IAD) is used to consolidate digitized data, voice and video traffic over a common wide area network (WAN) DSL link. This digitized voice stream may be encoded as mu-law or a-law voice samples, or it may comprise digitally encoded voice samples from an integrated services digital network (ISDN) phone. These digitally encoded voice samples are typically encapsulated in accordance with packet or cell protocol for transport over the network (e.g., using voice over asynchronous transfer mode (ATM) or voice over internet protocol (IP)).

Because digital subscriber line transport systems of the type shown in FIG. 1 are customarily designed to provide as efficient a use of the available bandwidth as possible, their major concern lies with parameters of the communication link, while secondarily they might address what takes place at an end user site that is interfaced with the link. At data terminal site, on the other hand, it is the performance of the data processing system that receives the principal emphasis. When these two subsystems are interfaced with one another, overall throughput efficiency may depend upon how well each is able to handle events that are characterized by protocols and data formats employed by the other subsystem. In fact, unexpected program flow occasionally may cause an unhandled software exception which, in turn, triggers a field reboot of the device. In some cases, the unexpected program flow or error condition may have happened up to several hundred or even more than a thousand instructions prior to the offending exception.

Resolving the cause of the exception is often complicated and customarily requires reproducing the problem in a controlled laboratory environment, where in-system analysis and development tools are readily available. This is a cumbersome, costly, and relatively slow approach to solving the problem. Moreover, for large numbers of field deployments, it is increasingly important to identify software defects and problem trends as early as possible. In addition to identifying the problem, it is also necessary to record relevant data that will enable the problem to be expeditiously resolved. Unfortunately, to date, this data has normally been available only from an in-system analysis tool.

### SUMMARY OF THE INVENTION

In accordance with the present invention, the above-described difficulties are successfully addressed by configuring various (unrecoverable) exception handlers that are distributed throughout the application firmware to save diagnostic information to non-volatile (e.g., FLASH) memory prior to initiating a reboot of the IAD. Having this information immediately stored allows a developer to query the IAD device ‘post-mortem’, and then reconstruct events leading to the failure, without having to connect a debugging station on site to the IAD. While knowledge of only the program counter of the offending instruction is particularly beneficial in diagnosing a problem, it is also useful to store a variety of other diagnostic data in the event of an unrecoverable exception, including, but not limited to the name and control information for the last running task, software revision information, run-time stack, and the like. Advantageously, the methodology of the present invention allows software defects to be analyzed and corrected in a matter of hours, as opposed to weeks or even months of conventional methodologies.

### BRIEF DESCRIPTION OF THE DRAWINGS

FIG. 1 is a reduced complexity diagram of the general architecture of a DSL system;

FIG. 2 is a flow chart of a conventional exception handler; and

FIG. 3 is a flow chart of the exception handler of FIG. 2 to incorporate the diagnostic data storage mechanism in accordance with the present invention.

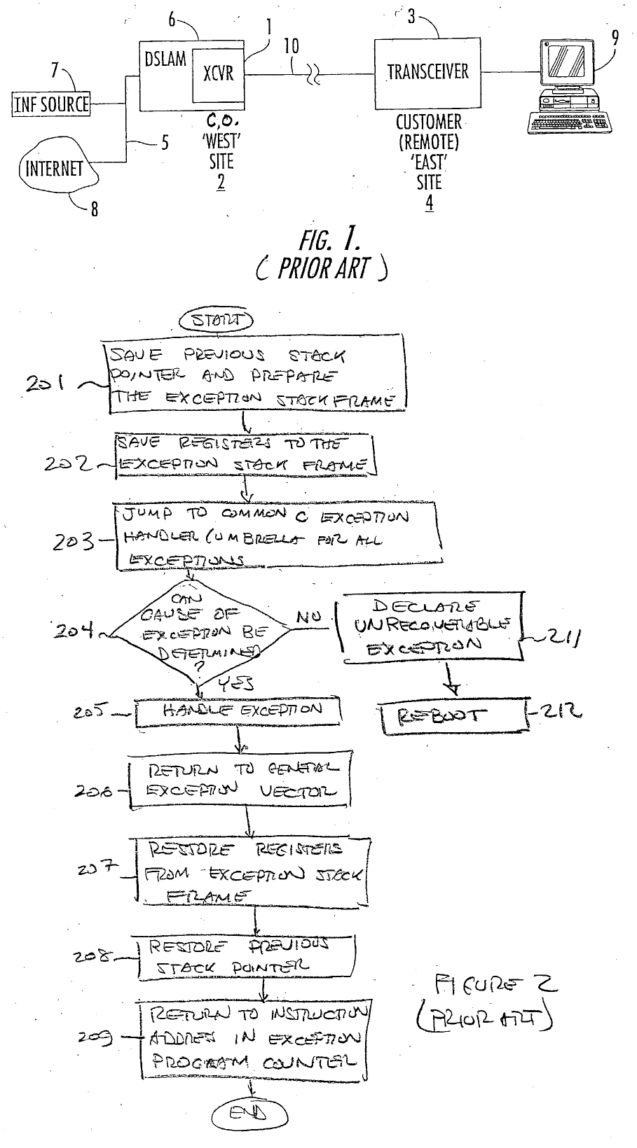

### DETAILED DESCRIPTION

Before describing in detail the (unrecoverable) exception-based, operational information storage mechanism in accordance with the present invention, it should be observed that the invention resides primarily in what is effectively a prescribed augmentation of signal processing control software, as may be employed by a micro-controller within a digital signaling interface unit, such as an integrated access device, referenced above. For purposes of providing a non-limiting but illustrative example, the control processor may comprise a MIPS-based architecture. The digital signaling interface unit itself may typically comprise a modular arrangement of conventional digital communication circuits and associated digital signal processing components and attendant supervisory control circuitry therefor, that controls the operations of such circuits and components. In a practical implementation that facilitates their incorporation into digital telecommunication equipment, these modular arrangements may be readily implemented as field programmable gate array (FPGA)-implemented, or application specific integrated circuit (ASIC) chip sets.

As a consequence, the configuration of these units and the manner in which they are interfaced with other communication equipment have been illustrated in the drawings by a readily understandable block diagram, which shows only those specific details that are pertinent to the present invention, so as not to obscure the disclosure with details which will be readily apparent to those skilled in the art having the benefit of the description herein. Thus, the block diagram and flow chart illustrations of the Figures are primarily intended to illustrate the major components of the system in convenient functional groupings, whereby the present invention may be more readily understood.

In order to facilitate an appreciation of the manner in which the unrecoverable exception-based information storage mechanism of the invention may be effectively interfaced with the general exception vector of a MIPS-based architecture, attention is directed to FIG. 2, which is a reduced complexity flow chart showing the manner in which exceptions are generally handled by that architecture. Upon the occurrence of an exception, at an initial step 201, the value of the previous stack pointer is saved and a dedicated portion of memory identified as an exception stack frame (ESF) is prepared. At step 202, the contents and identities of all registers are saved to the exception stack frame. Next, in step 203, the routine transitions to a common C exception handler (which is a general handler for all exceptions) . In this subroutine an attempt is made to determine the exact cause of the exception in step 204, the exception itself is handled in step 205, and the subroutine then returns to the general exception vector in step 206. With the exception processed, the contents of the registers, as saved in the exception stack frame, are then restored in step 207 and the value of the stack pointer is stored in step 208. The general exception vector concludes in step 209 by returning to the instruction address in the program counter. If the cause of the exception cannot be determined in step 204, the routine branches to an unexpected (in effect, unrecoverable) exception branch 211, which initiates a reboot of the system in step 212.

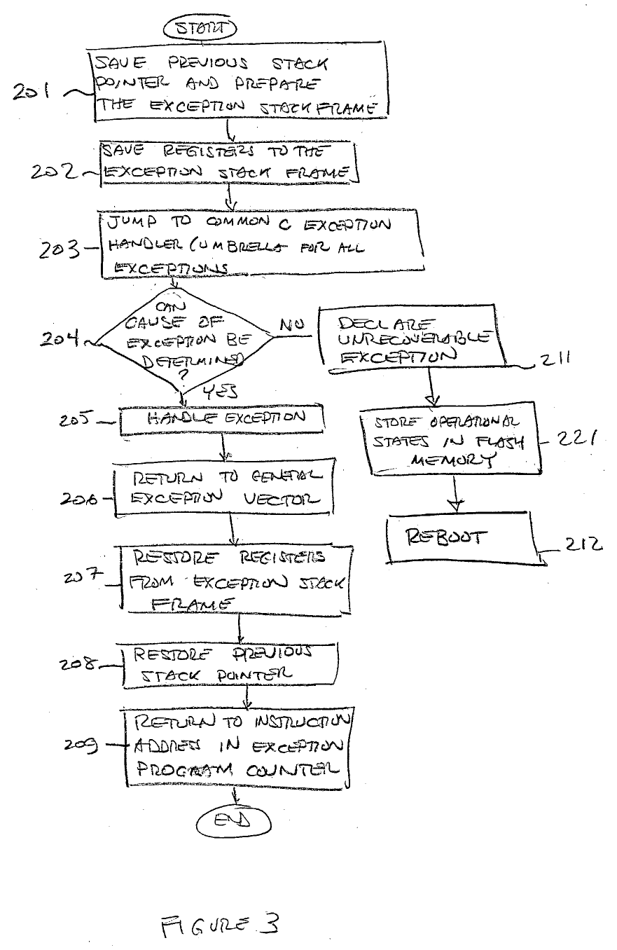

In accordance with the present invention, shown in the flow diagram of FIG. 3, prior to initiating a system reboot in step 212 of the flow diagram of FIG. 2, described above, the unexpected branch routine conducts a save-to-flash (non-volatile) memory step 221 of as much information as possible that will facilitate problem analysis and debugging of the software to determine what caused the unexpected exception. In accordance with a non-limiting, but preferred embodiment of the invention, the save-to-flash memory operation 221 stores the contents of all registers, name and task control information for the most recently running task, software revision information, the program counter of the offending instruction and the contents of the run-time stack. It should be noted that the invention is not limited to the storage of these or any other particular information items. The quantity of information stored is limited only by the capacity of the non-volatile memory used for the purpose. For the above items, a 64 KB sector of flash memory may be employed.

With the desired operational state information having been stored in non-volatile memory, the routine may proceed with system reboot in step 212. Since the data has been safely preserved, it may now be downloaded to an off-line site for evaluation by a system troubleshooting operator. It should also be noted that once a respective data capture section of non-volatile memory has been filled with the prescribed amount of data for which it is dedicated, no further data is written into that section of memory for that particular capture session.

The captured data, as well as any associated time of occurrence information, may then be transferred by way of a command over the controller's command bus to a separate signal processing operator, such as personal computer or network workstation and the like, for subsequent analysis. As a non-limiting example, the captured data may be downloaded from the JAD to the non-realtime environment of a debugging analysis station, so as to allow system troubleshooting personnel to analyze the captured data off-line, and thus obviate the need to dispatch service personnel to the remote site containing the IAD.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art. For instance, while the foregoing example has been described with reference to a DSL communication link, it is to be understood that the invention is applicable to other digital technologies including but not limited to T1 systems and the like.

What is claimed:

1. For use with a processor-controlled digital communication device that is adapted to process digitally encoded signals transported over a time division multiplex (TDM) communication path for assembly in accordance with a communication protocol, so that said digitally encoded signals may be transmitted over a digital communication link to a destination device, a method comprising the steps of:
(a) in response to the occurrence of an unrecoverable exception in the operation of said processor that causes an interruption in transmission of said digitally encoded signals over said digital communication link, storing to non-volatile memory information associated with prescribed operational conditions of said processor; and
(b) coupling said information from said non-volatile memory to a data analysis site separate from said processor-controlled digital communication device.

2. The method according to claim 1, wherein said processor-controlled digital communication device comprises an integrated access device.

3. The method according to claim 1, wherein step
(a) comprises storing to said non-volatile memory one or more of contents of all registers, name and task control information for the most recently running task, software revision information, the program counter of the instruction that causes said unrecoverable exception, and the contents of a run-time stack.

4. The method according to claim 1, wherein said non-volatile memory comprises flash memory.

5. A signal processing arrangement for use with a processor-controlled digital communication device that is adapted to process digitally encoded signals transported over a time division multiplex (TDM) communication path for assembly in accordance with a communication protocol, so that said digitally encoded signals may be transmitted over a digital communication link to a destination device, said signal processing arrangement comprising:
non-volatile memory storage mechanism which is operative, in response to the occurrence of an unrecoverable exception in the operation of said processor that causes an interruption in transmission of said digitally encoded signals over said digital communication link, to store in non-volatile memory information associated with prescribed operational conditions of said processor; and
a stored signal transport path which is operative to couple said information from said non-volatile memory to a data analysis site separate from said processor-controlled digital communication device.

6. The signal processing arrangement according to claim 5, wherein said processor-controlled digital communication device comprises an integrated access device.

7. The signal processing arrangement according to claim 5, wherein said non-volatile memory storage mechanism is operative to store to said non-volatile memory one or more of contents of all registers, name and task control information for the most recently running task, software revision information, the program counter of the instruction that causes said unrecoverable exception, and the contents of a run-time stack.

8. The signal processing arrangement according to claim 5, wherein said non-volatile memory comprises flash memory.
